(19) United States
(12) Patent Application Publication
(10) Pub. No.: US 2025/0158329 A1
(43) Pub. Date: May 15, 2025

(54) GANGWAY ASSEMBLY AND ELECTRICAL COUPLER ASSEMBLY FOR A MULTI-CAR VEHICLE, AND MULTI-CAR VEHICLE WITH THE GANGWAY ASSEMBLY OR ELECTRICAL COUPLER ASSEMBLY

(71) Applicant: Dellner Couplers AB, Falun (SE)

(72) Inventors: Peter LUNDBERG, Falun (SE); Andreas HOLMQUIST, Falun (SE); Bo NILSSON, Falun (SE)

(21) Appl. No.: 18/923,302

(22) Filed: Oct. 22, 2024

(30) Foreign Application Priority Data
Oct. 20, 2023 (EP) 23204905.6

(51) Int. Cl. H01R 13/631; B60D 5/00; B61D 17/22; B62D 47/02; H01R 13/639; H01R 43/26

(52) U.S. Cl. CPC H01R 13/6315; B60D 5/003; B61D 17/22; B62D 47/025; H01R 13/639; H01R 43/26; H01R 2201/26

(57) ABSTRACT

A gangway assembly comprising a gangway for arrangement between two cars of a multi-car vehicle having a first bellows with a frame for connecting to a counter frame of a second bellows of the gangway, a first electrical coupler connected to the frame of the first bellows and a second electrical coupler connected to the counter frame of the second bellows. A first support is connected to the frame of the first bellows. The first electrical coupler is movably mounted on the first support so as to be movable between an advanced position and a retracted position. A second support is fixedly connected to the second bellows counter frame, the second electrical coupler movably mounted on the second support and movable between an advanced position and a retracted position. An advancing mechanism advances the first and second electrical couplers from their respective retracted position to their respective advanced position.

### FIELD OF THE INVENTION

This invention relates to an electrical coupler assembly for a gangway of a multi-car vehicle, such as a bus or a tram or other rail vehicle, as well as to a gangway assembly comprising a corresponding electrical coupler assembly. The invention also relates to a multi-car vehicle with the electrical coupler assembly or gangway assembly.

### BACKGROUND

Multi-car vehicles, such as a bus or a tram, typically comprise a gangway between two adjacent cars for passengers to walk between the cars through the gangway. The adjacent cars are mechanically connected by means of mechanical couplers, which may be automatic couplers. In addition, electric wiring for transfer of energy and/or data extending along the multi-car vehicle needs to be connected and disconnected between two cars each time when cars are coupled or uncoupled, respectively, for which purpose electrical couplers are provided. In modern traffic, there is a large number of electric lines and, thus, an electrical coupler typically comprises an accordingly large number of plugs and/or sockets on a singular body for simultaneous connection. It is common to mount the electrical coupler to the mechanical coupler and arrange both together underneath the gangway. However, due to space constraints, it may be necessary to place the electrical coupler separate from the mechanical coupler, e.g. on a side or more typically on the top of the gangway.

U.S. Pat. No. 2,931,317 discloses a gangway with a bellows connected to one car of a multi-car vehicle, the bellows comprising a frame which connects to a counter frame provided on another car of the multi-car vehicle. An electrical coupler with electrical contacts is mounted to the frame on the outside of the bellows, and corresponding electrical counter contacts are provided above the counter frame of the other car. When the cars are brought together into a coupled relation, a male pin is the first to contact and become aligned with a female end of the car. An alignment member on the frame of the bellows is then aligned with a female alignment unit of the car. The electrical coupler may be resiliently mounted by springs to aid in establishing proper alignment and interconnection of corresponding abutting electrical contacts. The electrical contacts are provided with flat end surfaces and contact one another in that they are pressed rearwardly into respective housings against the action of springs.

EP 4098506 A1 considers it disadvantageous when the electrical coupler is exposed to severe weather conditions outside of the gangway. Furthermore, when the electrical coupling goes hand in hand with the mechanical coupling, it is not possible to electrically disconnect the cars independently from the mechanical coupling. EP 4098506 A1 suggests a gangway with two bellows. The electrical lines are guided through the frames of the bellows to electric hubs which are respectively mounted on the inside of the frames. Between the hubs, the electric lines are connected manually by means of bridging lines.

However, manual handling of electric lines inside the gangway is cumbersome and may even be hazardous.

### SUMMARY

It is an object of the present disclosure to provide an electric coupling between adjacent cars of a multi-car vehicle which is quick and safe.

According to one aspect of the present disclosure, a gangway assembly is provided which comprises:
a gangway for arrangement between two cars of a multi-car vehicle, wherein the gangway comprises a first bellows, the first bellows having a frame for connecting the first bellows to a counter frame of a second bellows of the gangway or to a counter frame of a car, and
a first electrical coupler and a second electrical coupler, wherein the first electrical coupler is connected to the frame of the first bellows and the second electrical coupler is either connected to the counter frame of the second bellows or configured to be connected to a car or counter frame of a car,
   wherein the gangway assembly further comprises one or both of:
a first support which is fixedly connected to the frame of the first bellows, wherein the first electrical coupler is movably mounted on the first support so as to be movable relative to the frame between an advanced position and a retracted position, and
a second support which is fixedly connected to the counter frame of the second bellows or adapted for being fixedly connected to a car or counter frame of a car, wherein the second electrical coupler is movably mounted on the second support so as to be movable relative to the counter frame or car between an advanced position and a retracted position,
   wherein the gangway assembly further comprises an advancing mechanism operable to advance one or both of the first and second electrical couplers from the respective retracted position to the respective advanced position.

Thus, the electrical couplers are mounted separate from the mechanical couplers, namely either on the frame and counter frame of the bellows, or on the frame of one bellows and on the car or counter frame of the car, respectively. By mounting the electrical couplers movably on corresponding supports, they can be safely and easily advanced from their disconnected position to a connected position independent from a mechanical coupling of the cars. In particular, advancing and, thus, connection of the electrical couplers is achieved via an advancing mechanism so that manual handling of individual electric lines is avoided.

While it is generally sufficient if only one of the two electrical couplers is movably mounted whereas the other is stationary, it is preferred that both the first electrical coupler is movably mounted on the first support and the second electrical coupler is movably mounted on the second support. In other words, the arrangement is symmetric. This is advantageous for multi-car vehicles, such as longer passenger trains, where the cars can be turned by 180° with respect to each other and must nevertheless permit their connection.

Further preferably, it may be advantageous to arrange the first and/or second electrical couplers outside the gangway, in particular on an outside of the frame and counter frame, respectively, in order to keep the inside of the gangway as free as possible.

The advancing mechanism is preferably operable from inside the gangway, in particular manually operable. This facilitates a quick coupling of two adjacent cars since, usually, the frame and counter frame are connected by respective personnel from inside the gangway, and if the advancing mechanism is operable from inside the gangway as well, the electrical coupling can be done right after the mechanical connection of the frames.

Preferably, the frame comprises a through hole connecting an inner side of the frame with the outer side of the frame, wherein the advancing mechanism extends through the through hole from inside the first bellows to outside the first bellows and is operable from inside the first bellows. The same may apply in relation to the counter frame. In particular, the advancing mechanism may comprise a first part and a second part which is separate from but identical in function to the first part, wherein the first part is configured to cooperate with the first electrical coupler and the second part is configured to cooperate with the second electrical coupler. Thus, whenever reference is made to the advancing mechanism hereinafter, this implies that it may comprise two corresponding parts.

In one embodiment, the advancing mechanism comprises an operating spindle which extends through the through hole and which is configured so that turning the operating spindle causes advancement of the first electrical coupler from its retracted position to its advanced position. This allows for attaching a motor or a manually operated handle to the innermost end of the spindle in order to operate the advancing mechanism.

At the operating spindle's respective other end, the advancing mechanism may comprise an advancement shaft, wherein the operating spindle and advancement shaft engage each other so that turning the operating spindle causes advancement of the corresponding electrical coupler from its retracted position to its advanced position by means of the advancement shaft. In a preferred embodiment, the advancement shaft may be stationary and have a thread which engages a part of the electrical coupler so that rotation of the advancement shaft causes advancement of the first electrical coupler from its retracted position to its advanced position by means of the advancement shaft. Alternatively, the advancement shaft may be fixedly connected to the electrical coupler and move with the electrical coupler when the operating spindle is turned.

In one variant, the operating spindle and advancement shaft engage each other by means of a worm gear. The worm gear may have a trapezoidal threading in order to render the worm gear self-locking.

In another variant, the operating spindle and advancement shaft engage each other by means of a swing lever. This arrangement is less complex.

Furthermore, a marker may be provided which is visible from inside the gangway, and an indicator may be provided which is likewise visible from inside the gangway and arranged such that it changes position relative to the marker when the electrical coupler moves from its retracted position to its advanced position, e.g. when the aforementioned operating spindle is being turned. Thus, the indicator is preferably arranged on the operating spindle, whereas the marker may be arranged on an inner side of the frame. This way, the personnel can easily identify from the position of the indicator relative to the marker whether or not the first and second electrical couplers are in a coupled or uncoupled state.

As mentioned, a handle may be provided for manual operation of the advancing mechanism. Preferably, the handle is removable so as not to extend into the gangway and to avoid unauthorized use thereof. Thus, the removable handle may be configured to be connected to the advancing mechanism from inside the gangway and for manually operating the advancing mechanism from inside the gangway so as to advance the corresponding electrical coupler from its retracted position to its advanced position.

Alternatively, a motor may be provided and configured to drive the advancing mechanism so as to advance the corresponding electrical coupler from its retracted position to its advanced position. The motor further facilitates the operation of the advancing mechanism. One motor may be provided for each of the first and second electrical couplers. The motor may be provided in addition to the handle, so that the handle may need to be used only in case of a failure of the motor. The motor may be operable from inside the gangway, either remotely or manually, such as by entering a code or the like on a corresponding touch pad. In particular, the motor may be arranged inside the first bellows.

Furthermore, at least one of the first and second electrical couplers may comprise a movable front cover which is movable between a closed position, in which it covers electrical contacts of the electrical coupler, and an open position, in which the electrical contacts are uncovered and ready for coupling with electrical contacts of the respective other electrical coupler. This is particularly advantageous where the electrical couplers are arranged outside the gangway, namely to protect the electrical contacts against snow and ice. But this is likewise advantageous for electrical couplers which are placed inside the gangway, namely to protect the electrical contacts from being unintentionally touched in an uncoupled state of the electrical couplers. Preferably, both the first electrical coupler and the second electrical coupler comprise such a movable front cover.

In one embodiment, the movable front cover is configured to open automatically when the first and second electrical couplers approach each other. For instance, the front covers may contact each other when the electrical couplers are moved toward each other and, upon further advancement of at least one of the electrical couplers, press against each other and push each other into an open state. A spring may be provided on one or preferably both front covers to urge the front cover back toward its closed state when the electrical couplers move apart. Alternatively or in addition, the front cover may be hingedly mounted by means of a lever, wherein the lever is guided so as to rotate relative to the electrical coupler when the electrical coupler is being advanced.

The gangway assembly may further comprise a locking mechanism which is configured to permit, after the frame has been connected to the counter frame and prior to operating the advancing mechanism so as to advance one or both of the first and second electrical couplers from the respective retracted position to the respective advanced position, locking the frame to the counter frame. This way, the frame and counter frame are maximally aligned, thereby pre-aligning the electrical couplers relative to each other before the advancing mechanism is operated. This helps to prevent damage to the electrical couplers and, in particular, their electrical couplers (plugs and sockets).

An elastic connection may be provided to permit elastic movement of at least one of the first and second electrical couplers in a direction perpendicular to a longitudinal extension of the first bellows. That is, for the case that the pre-alignment is not sufficiently exact for the electrical couplers of the two electrical couplers to perfectly mate, further alignment is automatically achieved by means of the elastic connection. While the tip ends of the male connectors (plugs) are typically tapered and, thus, guided into the female connectors (sockets) upon forward movement, this action is facilitated by permitting the electrical coupler or couplers to elastically flex sideways, if needed.

In a preferred embodiment, the elastic connection may be realized by at least one, preferably both, of the first and second electrical couplers being elastically mounted on a respective one of the first and second supports so as to permit such sideways movement. More specifically, the electrical coupler or couplers may be elastically mounted on the associated support by means of an elastomeric material or rubber.

Preferably, the first electrical coupler has a first set of redundant electrical contacts and the second electrical coupler has a second set of redundant electrical contacts arranged to mate with the first set of redundant electrical contacts of the first electrical coupler. Herein, the arrangement of the first and second sets of redundant electrical contacts is symmetrical with respect to a vertical mid-plane of the respective first and second electrical couplers such that the first set of redundant electrical contacts of the first electrical coupler can mate with the second set of redundant electrical contacts of the second electrical coupler.

According to another aspect of the present disclosure, an electrical coupler assembly is provided which comprises a first electrical coupler and a second electrical coupler, the electrical coupler assembly further comprising one or both of:
a first support which is configured to be fixedly connected to a frame of a first bellows of a gangway of a multi-car vehicle, wherein the first electrical coupler is movably mounted on the first support so as to be movable relative to the first support between an advanced position and a retracted position, and
a second support which is configured to be fixedly connected to a counter frame of a second bellows of a gangway of a multi-car vehicle or to a car or counter frame of a car of a multi-car vehicle, wherein the second electrical coupler is movably mounted on the second support so as to be movable relative to the second support between an advanced position and a retracted position,
   wherein the electrical coupler assembly further comprises an advancing mechanism operable to advance one or both of the first and second electrical couplers from the respective retracted position to the respective advanced position.

The electrical coupler arrangement may have the same structure and provide the same functions as the first and second couplers of the gangway assembly described above.

According to an even further aspect of the present disclosure, there is provided a multi-car vehicle which comprises a gangway assembly and/or an electrical coupler assembly as described above.

### BRIEF DESCRIPTION OF THE DRAWINGS

The foregoing summary as well as the following detailed description of preferred embodiments will be better understood when read in conjunction with the appended drawings. For the purpose of illustrating the present disclosure, reference is made to the drawings. The scope of the disclosure, however, is not limited to the specific embodiments disclosed in the drawings.

In the drawings:

FIG. 1 shows a gangway assembly with electrical couplers on top of the gangway, FIGS. 2A to 2C show the electrical couplers of FIG. 1 in different operational positions in a side view,

FIG. 3 is a perspective view of the electrical couplers of FIG. 1 in a non-operational, retracted state,

FIG. 4 is a perspective view of the electrical couplers of FIG. 1 in an operational state,

FIGS. 5A and 5B show the gangway and couplers of FIG. 1 in cross-section in a perspective view and side view, respectively.

FIG. 6 is a perspective view into the gangway of FIG. 1 with a handle for operating the electrical couplers from inside the gangway,

FIG. 7 is a detailed view of the inner top side of the gangway with the operating handle shown in FIG. 6,

FIG. 8 is a perspective view of an electrical coupler according to a first embodiment,

FIGS. 9A and 9B show a cross-section of the electrical coupler of FIG. 8 in a perspective view and top view, respectively,

FIG. 10 is a perspective view of an electrical coupler according to a second embodiment,

FIGS. 11A and 11B show details of the electrical coupler of FIG. 10 mounted on a gangway and

FIG. 12 illustrates the arrangement of electrical connections of an electrical coupler.

### DETAILED DESCRIPTION

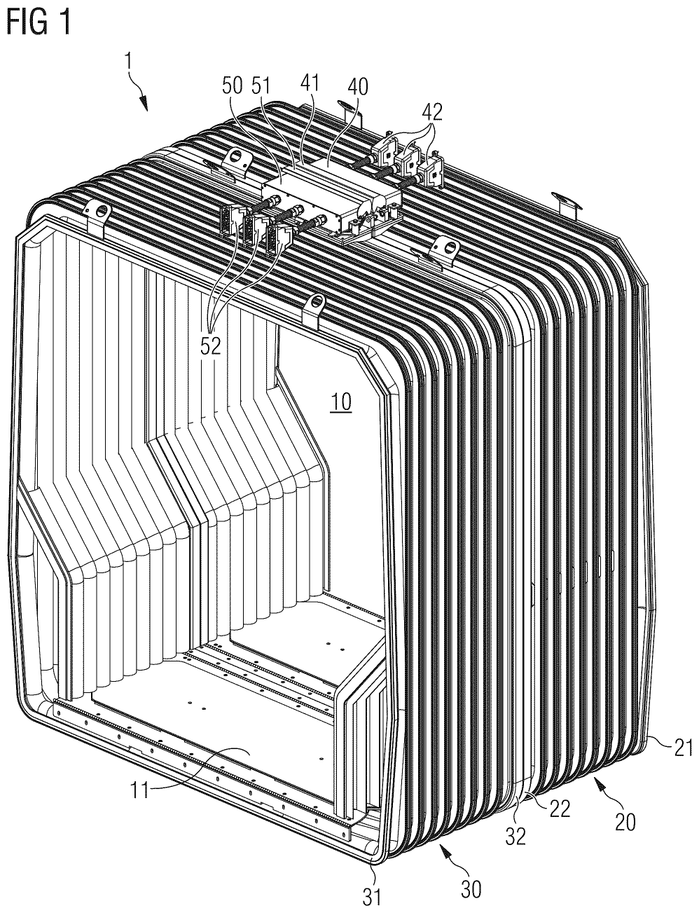

FIG. 1 illustrates a gangway assembly comprising a gangway 1 and two electrical couplers 40, 50 mounted on the top thereof. The arrangement of the electrical couplers 40, 50 could likewise be on a side of the gangway 1. In the situation shown in FIG. 1, the electrical couplers 40, 50 contact each other with their respective front ends, whereas electrical lines 42, 52 lead into their respective rear ends. Three electrical lines 42, 52 are shown, but there may be more or fewer electrical lines. The electrical couplers 40, 50 and electrical lines 42, 52 serve to establish an electrical connection between two adjacent cars of a multi-car vehicle. For this purpose, the electrical lines 42, 52 each have a plug for connecting the electrical lines 42, 52 to corresponding sockets on the adjacent cars.

The gangway 1 comprises two bellows 20, 30. Each of the bellows comprises a mounting frame 21, 31 by means of which the bellows 20, 30 are mounted on a respective open end of a car of the multi-car vehicle (not shown). On the respective other end of the bellows 20, 30, end frames 22, 32 are provided. When two adjacent cars of a multi-car vehicle are coupled together, the end frames 22, 32 are brought in contact with each other and are usually locked to each other manually. A suitable locking mechanism is e.g. disclosed in EP 2002998 A1. Hereinafter, the end frame 22 may sometimes be referred to as “frame” or “first frame”, whereas the other end frame 32 may sometimes be referred to as “counter frame” or “second frame”. When the end frames 22, 32 are locked to each other, the gangway 1 is closed and provides a passage 10 between the two adjacent cars. That is, the bellows 20, 30 and their mounting frames 21, 31 and end frames 22, 32 are each circumferentially closed.

When adjacent cars of a multi-car vehicle are coupled to each other, they are usually coupled mechanically by means of mechanical couplers which are usually arranged underneath the floor 11 of the gangway 1 and, as mentioned, the gangway is closed by connecting the end frames 22, 32 of the bellows 20, 30 to each other. The gangway 1 may have more than two bellows or even a single bellows 20. In the case of a single bellows 20, the counter frame 32 to which the end frame 22 of the single bellows 20 is attached may make part of a car.

In addition to closing the mechanical coupler and the gangway 1, the electrical couplers 40, 50 need to be interconnected. This is shown in more detail in FIGS. 2A to 2C. FIG. 2A shows the electrical couplers 40, 50 arranged on top of the bellows 20, 30 in a situation where the gangway 1 is not yet closed, i.e. the end frames 22, 32 of the bellows 20, 30 are at a distance from each other. In this position, front covers 41, 51 of the electrical couplers 40, 50 are in a closed position in which they cover electrical contacts against the environment. FIG. 2B shows the bellows 20, 30 in a closed situation in which the end frames 22, 32 contact each other. As can be seen, the front covers 41, 51 are partly open. More specifically, as the bellows 20, 30 are moved toward each other and the couplers 41, 51 touch each other, the front covers 41, 51 push each other open, thereby rotating about hinges 43, 53, respectively. In a preferred embodiment, as shown in FIG. 2A to 2C, the front covers 41, 51 contact each other with a respectively curved front surface so that the front covers 41, 51 rotate about the hinges 43, 53 when the electrical couplers 40, 50 approach each other. A return spring 44, 54 may be provided to urge the front covers 41, 51 back into their respective closed positions when the electrical couplers 40, 50 are moved apart.

FIG. 2C shows the final step of coupling the electrical couplers 40, 50. That is, in order to couple the electrical couplers 40, 50 electrically, the electrical couplers 40, 50 are moved even further toward and against each other until their electrical contacts (not shown) mate. This state is shown in FIG. 2C. As can be seen from a comparison of FIGS. 2B and 2C, the electrical couplers 40, 50 have moved relative to a support 70, 80 by which they are mounted on the top of the end frames 22, 32. Meanwhile, the front covers 41, 51 have moved from their partly open position shown in FIG. 2B to a fully open position shown in FIG. 2C. The fully open position is, again, achieved by the front covers 41, 51 pushing against each other and rotating about the hinges 43, 53, respectively, when the electrical couplers 40, 50 move toward each other into their coupled state.

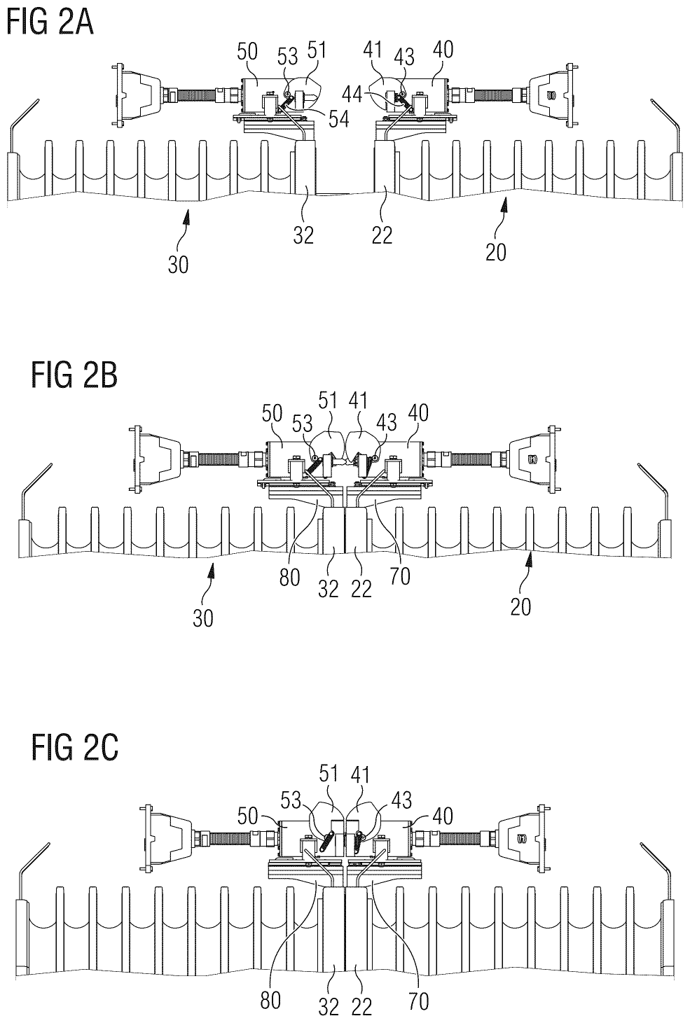

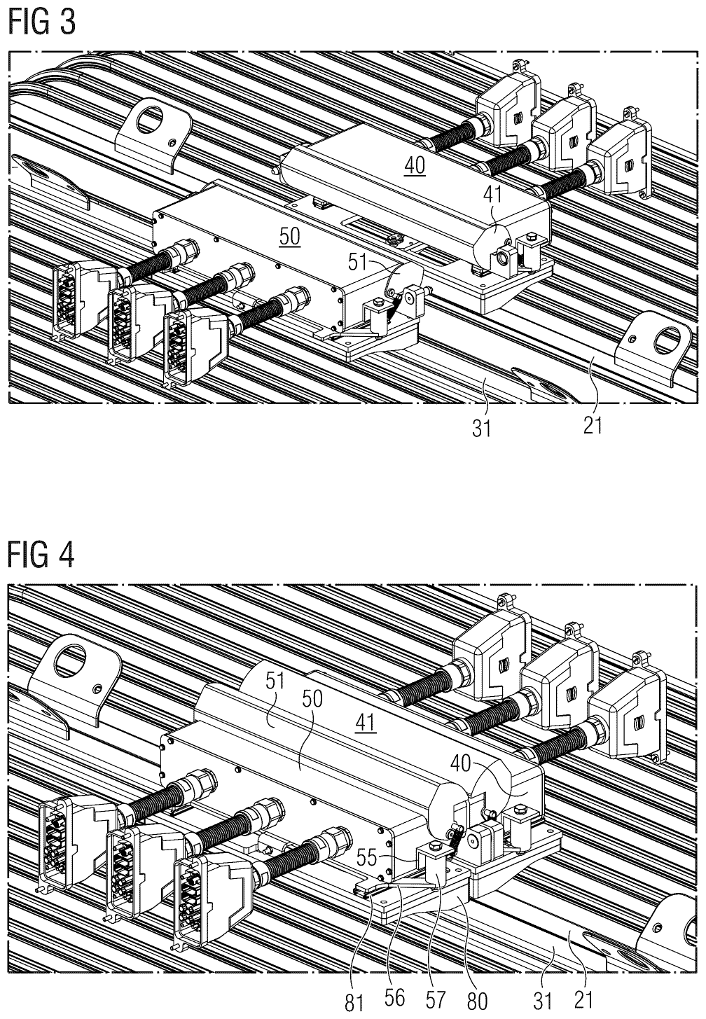

FIGS. 3 and 4 are detailed perspective views of the electrical couplers 40, 50 in their closed state, i.e. when the end frames 22, 32 are distanced from each other, and in a coupled state, in which the end frames 22, 32 are connected to each other and the electrical couplers 40, 50 are advanced so that their electrical contacts mate, respectively. This corresponds to the situations as shown in FIGS. 2A and 2C, whereas the perspective view shown in FIG. 1 corresponds to the situation shown in FIG. 2B, i.e. the situation where the gangway 1 is closed but the electrical contacts 40, 50 are not coupled yet. As can be seen e.g. from FIG. 4, the electrical coupler 50 comprises a holder 55 holding a housing in which the electrical contacts (not shown) are contained and further comprises a sledge 56 which is slidably movable in guides 81 of the support 80. An elastic connection 57 between the holder 55 and the sledge 56 allows the electrical coupler 50 to slightly move sideways when the electrical couplers 40, 50 are coupled to each other. This way, misalignments of the end frames 21, 31 or misalignment of the electrical couplers 40, 50 on the end frames 21, 31 can be compensated during the process of coupling the electrical couplers 40, 50. The clastic connection 57 may be made from an elastomeric material or rubber. Of course, the elastic connection 57 as well as the guides 81 for the sledge 56 are provided identically on both sides of the electrical coupler 50. The electrical coupler 40 is constructed identical to the electrical coupler 50. This applies to all embodiments disclosed herein and ensures that adjacent cars can be coupled to each other independent of their ends with which they are facing each other.

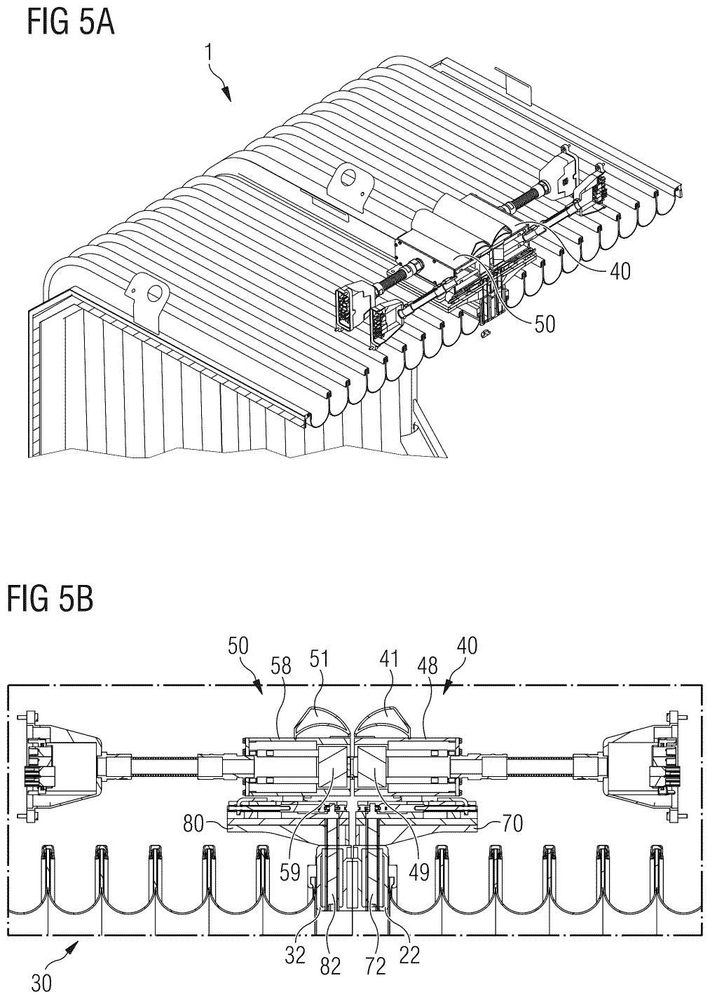

FIG. 5A is a cross-sectional perspective view of the gangway 1 with the two electrical couplers 40, 50 in a coupled state, and FIG. 5B is a detailed cross-sectional side view thereof. As can be seen, the front covers 41, 51 are in the fully open position. In the housings 48, 58 of the electrical couplers 40, 50, electrical connector blocks 49, 59 are accommodated and comprise electrical contacts which are mating with each other. The electrical couplers 40, 50 are mounted on top of the end frames 22, 32 by means of the supports 70, 80. Since the electrical couplers 40, 50 are arranged on an outer side of the end frames 22, 23, the advancing mechanism is configured to be operable from inside the gangway. For this purpose, the end frames 22, 23 each comprise a through hole connecting an inner side of the respective end frame with the outer side thereof, and the advancing mechanism extends through the through hole so as to be operable from inside the gangway 1. To this end, the advancing mechanism for advancing the electrical couplers 40, 50 from their respective retracted positions to their respective advanced positions comprises operating spindles 72, 82 extending through the through holes. Turning an operating spindle 72 and 82, respectively, causes advancement of the corresponding electrical coupler 40 and 50, respectively, from its retracted position to its advanced position. Turning the operating spindles 72, 82 in an opposite direction causes retraction of the electrical couplers from their advanced position to their retracted position. While the electrical coupler 40 mounted on the end frame 22 (‘first frame’), the electrical coupler 50 does not necessarily need to be mounted on the end frame 32 (‘counter frame’) of the second bellows 30 but may likewise be mounted on a counter frame of a car of the multi-car vehicle or directly on the car, e.g. in the case where the gangway 1 comprises a single bellows.

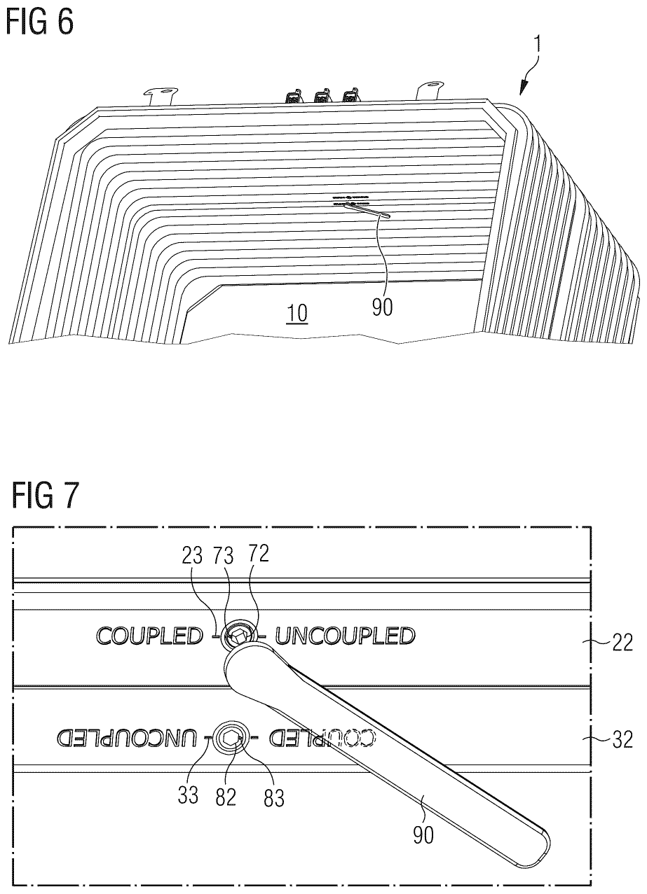

The lower end of the operating spindle 72, 82 reaching into the gangway 1 may be operated manually by means of a handle, as shown in FIGS. 6 and 7 or, e.g. by means of a motor which may be mounted on an inner side of the respective end frame 22, 32. Thus, as can be seen from the perspective inside view of the gangway 1 as shown in FIG. 6, personnel standing in the passage 10 may use a handle 90 to turn the operating spindles 72, 82 between a coupled and an uncoupled position. Indicators 73 and 83 on the operating spindles 72, 82 are aligned with a marker 23 and 33 on the end frames 22, 32, respectively, as illustrated in the detailed view in FIG. 7.

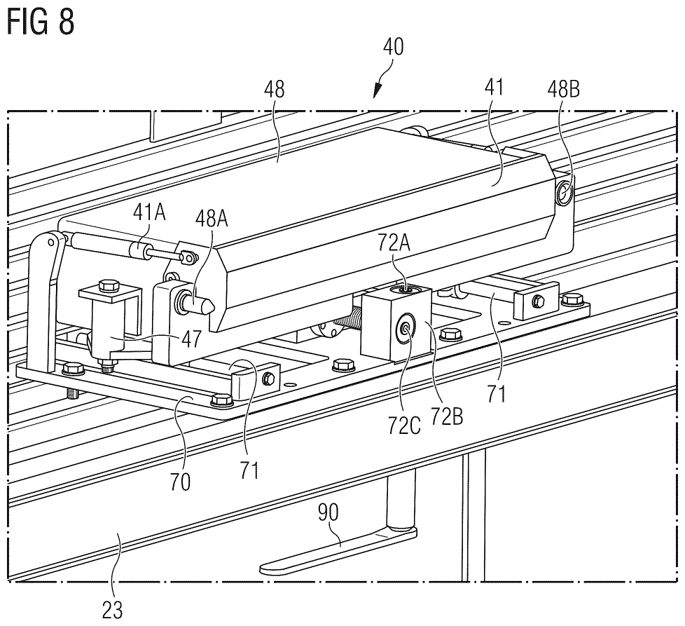

FIG. 8 shows a first embodiment of an electrical coupler 40 in which the operating mechanism comprises a worm gear transmission. More specifically, the electrical coupler 40 is movably mounted on the support 70 by means of a guide 71. In this embodiment, the guide 71 consists of two guide rails in the form of parallel rods. A pin 48A and a pin hole 48B are arranged on opposite sides of the housing 48 in order to mate and align with a corresponding pin and pin hole (not shown) of a corresponding second electrical coupler 50. When the electrical couplers 40, 50 are coupled and aligned by means of the pins and pin holes, the clastic connections 47 and 57 associated with the electrical couplers 40, 50 permit an elastic movement of the electrical couplers 40, 50 in a direction perpendicular to a longitudinal extension of the gangway 1, i.e. in a sideways direction and/or upward direction, in order to compensate for misalignment of the end frames 22, 23 or incorrect mounting of the electrical couplers 40, 50 on the end frames 22, 23.

In this embodiment automatic opening of the front cover 41 upon advancement of the electrical coupler 40 is achieved by means of the lever 41A, which is in this case a gas strut. The lever 41A is hinged with one end to the support 70 and with the opposite end to the front cover 41, the front cover 41 rotating about the hinge 43.

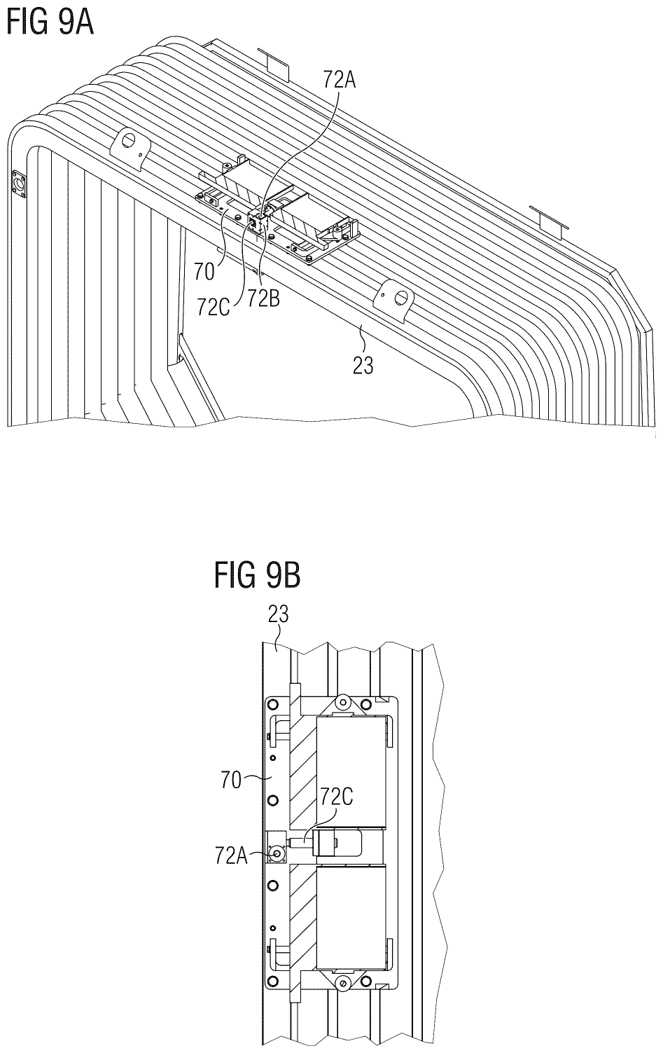

Next, the worm gear transmission will be described. That is, the operating spindle 72 being operated by the handle 90 and extending through the end frame 23 reaches with its upper end 72A into a gear box 72B where it engages an advancement shaft 72C by means of a worm gear connection. Turning the operating spindle 72 causes advancement of the electrical coupler 40 from its retracted position, shown in FIG. 8, to its advanced position by means of the advancement shaft 72C. In so far, the advancement shaft 72C is stationary and has a thread which engages a part of the electrical coupler 40 so that rotation of the advancement shaft 72C via the worm gear connection causes advancement of the electrical coupler 40. Details of the worm gear connection can be taken from the cross-sectional perspective view in FIG. 9A and top view in FIG. 9B, respectively.

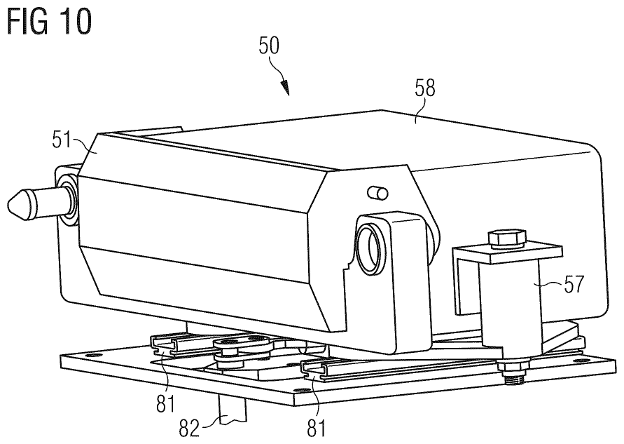

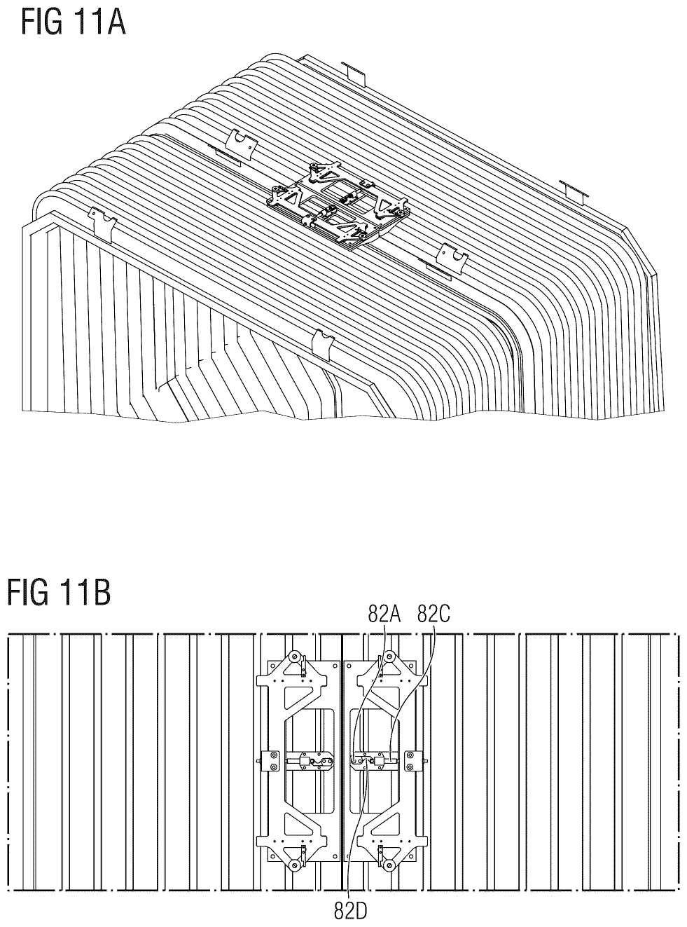

FIG. 10 is a perspective view of an electrical coupler 50 according to a second embodiment. The electrical coupler 50 differs from the electrical coupler 40 of the first embodiment only in that the guide 81 is formed by two guide rails 81, in which the electrical coupler 50 is slidably guided and, furthermore, in that the transmission between the operating spindle 82 and the advancement shaft 72C does not include a worm gear connection but an over-knee mechanism. This is further shown in FIGS. 11A and 11B which show a part of the mechanism perspectively and as a top view, respectively. Accordingly, the advancement shaft 82C is connected to the upper end 82A of the operating spindle 82 by means of a swing lever 82D. Turning the operating spindle 82 by 180° causes the swing lever 82D to rotate about the upper end 82A of the operating spindle 82, thereby pulling the advancement shaft 82C. Of course, the advancement shaft 82C may have any form and may even be integrally formed with the housing 58 of the electrical coupler 50. While an electrical coupler 40 according to the first embodiment and an electrical coupler 50 according to the second embodiment may cooperate with each other for coupling, it is preferred that the electrical couplers 40, 50 mounted to the cars of a multi-car vehicle are identical.

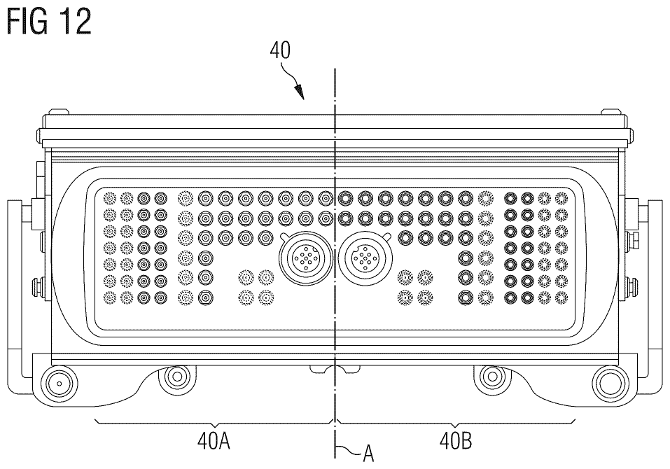

FIG. 12 shows an electrical coupler 40 without the front cover 41 removed so that the electrical contacts thereof are exposed. The electrical coupler 40 has a first set of electrical contacts 40A and a second set of electrical contacts 40B. The two sets of electrical contacts 40A, 40B are arranged symmetrically with respect to a vertical mid-plane A and they are redundant to each other, meaning that the electrical contacts of the first set of electrical contacts 40A have the same function as the electrical contacts of the second set of electrical contacts 40B. This has the effect that the first set of redundant electrical contacts 40A of a first electrical coupler 40 can mate with the second set of redundant electrical contacts 40B of a second electrical coupler 40.

Preferred aspects of the present disclosure are specified in the following paragraphs:

1. A gangway assembly, comprising:
a gangway 1 for arrangement between two cars of a multi-car vehicle, wherein the gangway 1 comprises a first bellows 20, the first bellows 20 having a frame 22 for connecting the first bellows 20 to a counter frame 32 of a second bellows 30 of the gangway 1 or to a counter frame of a car, and
a first electrical coupler 40 and a second electrical coupler 50, wherein the first electrical coupler 40 is connected to the frame 22 of the first bellows 20 and the second electrical coupler 50 is either connected to the counter frame 32 of the second bellows 30 or configured to be connected to a car or counter frame of a car,
   wherein the gangway assembly further comprises one or both of:
a first support 70 which is fixedly connected to the frame 22 of the first bellows 20, wherein the first electrical coupler 40 is movably mounted on the first support 70 so as to be movable relative to the frame 22 between an advanced position and a retracted position, and
a second support 80 which is fixedly connected to the counter frame 32 of the second bellows 30 or adapted for being fixedly connected to a car or counter frame of a car, wherein the second electrical coupler 50 is movably mounted on the second support 80 so as to be movable relative to the counter frame 32 or car between an advanced position and a retracted position,
   wherein the gangway assembly further comprises an advancing mechanism 72, 72C, 82, 82C operable to advance one or both of the first and second electrical couplers 40, 50 from the respective retracted position to the respective advanced position.
   2. The gangway assembly according to paragraph 1, wherein the gangway assembly comprises both the first support 70 on which the first electrical coupler 40 is movably mounted and the second support 80 on which the second electrical coupler 50 is movably mounted.
   3. The gangway assembly according to paragraph 1 or 2, wherein the first electrical coupler 40 is arranged on an outer side of the frame 22.
   4. The gangway assembly according to any one of paragraphs 1 to 3, wherein the advancing mechanism 72, 72C, 82, 82C is operable from inside the gangway 1.
   5. The gangway assembly according to paragraph 4, wherein the advancing mechanism 72, 72C, 82, 82C is manually operable from inside the gangway 1.
   6. The gangway assembly according to any one of paragraphs 1 to 5, wherein the frame 22 comprises a through hole connecting an inner side of the frame 22 with an outer side of the frame 22, wherein the advancing mechanism 72, 72C, 82, 82C extends through the through hole from inside the first bellows 20 to outside the first bellows 20 and is operable from inside the first bellows 20.
   7. The gangway assembly according to paragraph 6, wherein the advancing mechanism 72, 72C, 82, 82C comprises an operating spindle 72 which extends through the through hole and which is configured so that turning the operating spindle 72 causes advancement of the first electrical coupler 40 from its retracted position to its advanced position.
   8. The gangway assembly according to paragraph 7, wherein the advancing mechanism 72, 72C, 82, 82C further comprises an advancement shaft 72C, wherein the operating spindle 72 and advancement shaft 72C engage each other so that turning the operating spindle 72 causes advancement of the first electrical coupler 40 from its retracted position to its advanced position by means of the advancement shaft 72C.
   9. The gangway assembly according to paragraph 8, wherein the advancement shaft 72C is stationary and has a thread which engages a part of the first electrical coupler 40 so that rotation of the advancement shaft 72C causes the advancement of the first electrical coupler 40 from its retracted position to its advanced position.
   10. The gangway assembly according to paragraph 8 or 9, wherein the operating spindle 72 and advancement shaft 72C engage each other by means of a worm gear.
   11. The gangway assembly according to paragraph 8 or 9, wherein the operating spindle 72 and advancement shaft 72C engage each other by means of a swing lever 82D.
   12. The gangway assembly according to any one of paragraphs 1 to 11, further comprising a marker 23 which is visible from inside the gangway 1 and an indicator 73 which is likewise visible from inside the gangway 1 and arranged such that it changes position relative to the marker 23 when the first electrical coupler 40 moves from its retracted position to its advanced position.
   13. The gangway assembly according to paragraph 12, wherein the marker 23 is arranged on an inner side of the frame 22.
   14. The gangway assembly according to any one of paragraphs 7 to 11, including paragraph 12 or 13, wherein the indicator 73 is arranged on the operating spindle 72.
   15. The gangway assembly according to any one of paragraphs 1 to 14, further comprising a removable handle 90 which is configured to be connected to the advancing mechanism 72, 72C from inside the gangway 1 and for manually operating the advancing mechanism 72, 72C from inside the gangway 1 so as to advance the first electrical coupler 40 from its retracted position to its advanced position.
   16. The gangway assembly according to any one of paragraphs 1 to 15, further comprising a motor which is configured to drive the advancing mechanism 72, 72C so as to advance the first electrical coupler 40 from its retracted position to its advanced position.
   17. The gangway assembly according to paragraph 16, wherein the motor is operable from inside the first bellows 20.
   18. The gangway assembly according to paragraph 16 or 17, wherein the motor is arranged inside the first bellows 20.
   19. The gangway assembly according to any one of paragraphs 1 to 18, wherein at least one of the first and second electrical couplers 40, 50 comprises a movable front cover 41, 51 which is movable between a closed position, in which it covers electrical contacts of said one of the first and second electrical couplers 40, 50, and an open position, in which the electrical contacts are uncovered and ready for coupling with electrical contacts of the respective other one of the first and second electrical couplers 40, 50.
   20. The gangway assembly according to paragraph 19, wherein both the first electrical coupler 40 and the second electrical coupler 50 each comprise the movable front cover 41, 51.
   21. The gangway assembly according to paragraph 19 or 20, wherein the movable front cover 41, 51 is configured to open automatically when the first and second electrical couplers 40, 41 approach each other.
   22. The gangway assembly according to any one of paragraphs 1 to 21, further comprising a locking mechanism which is configured to permit, after the frame 22 has been connected to the counter frame 32 and prior to operating the advancing mechanism 72, 72C, 82, 82C so as to advance one or both of the first and second electrical couplers 40, 50 from the respective retracted position to the respective advanced position, locking the frame 22 to the counter frame 32.
   23. The gangway assembly according to any one of paragraphs 1 to 22, comprising an elastic connection 47, 57 which permits elastic movement of at least one of the first and second electrical couplers 40, 50 in a direction perpendicular to a longitudinal extension of the first bellows 20.
   24. The gangway assembly according to paragraph 23, wherein the elastic connection 47, 57 is realized by at least one of the first and second electrical couplers 40, 50 being elastically mounted on a respective one of the first and second supports 70, 80 so as to allow movement of said at least one of the first and second electrical couplers 40, 50 in a direction perpendicular to an advancement direction of said at least one of the first and second electrical couplers 40, 50.
   25. The gangway assembly according to paragraph 24, wherein said at least one of the first and second electrical couplers 40, 50 is elastically mounted on said respective one of the first and second supports 70, 80 by means of an elastomeric material or rubber.
   26. The gangway assembly according to any one of paragraphs 1 to 25, wherein the first electrical coupler 40 has a first set of redundant electrical contacts 40A, 40B and the second electrical coupler 50 has a second set of redundant electrical contacts arranged to mate with the first set of redundant electrical contacts 40A, 40B of the first electrical coupler 40, wherein the arrangement of the first and second sets of redundant electrical contacts is symmetrical with respect to a vertical mid-plane A of the respective first and second electrical couplers 40, 50 such that the first set of redundant electrical contacts 40A, 40B of the first electrical coupler 40 can mate with the second set of redundant electrical contacts of the second electrical coupler 50.
   27. The gangway assembly according to any one of paragraphs 1 to 26, wherein the advancing mechanism 72, 72C, 82, 82C comprises a first part 72, 72C and a second part 82, 82C which is separate from but identical in function to the first part 72, 72C, wherein the first part 72, 72C is configured to cooperate with the first electrical coupler 40 and the second part 82, 82C is configured to cooperate with the second electrical coupler 50.
   28. An electrical coupler assembly comprising a first electrical coupler 40 and a second electrical coupler 50, comprising one or both of:
a first support 70 which is configured to be fixedly connected to a frame 22 of a first bellows 20 of a gangway 1 of a multi-car vehicle, wherein the first electrical coupler 40 is movably mounted on the first support 70 so as to be movable relative to the first support 70 between an advanced position and a retracted position, and
a second support 80 which is configured to be fixedly connected to a counter frame 32 of a second bellows 30 of a gangway 1 of a multi-car vehicle or to a car or counter frame of a car of a multi-car vehicle, wherein the second electrical coupler 50 is movably mounted on the second support 80 so as to be movable relative to the second support 80 between an advanced position and a retracted position,
   wherein the electrical coupler assembly further comprises an advancing mechanism 72, 72C, 82, 82C operable to advance one or both of the first and second electrical couplers 40, 50 from the respective retracted position to the respective advanced position.
   29. A multi-car vehicle, comprising the gangway assembly according to any one of paragraphs 1 to 27 or the electrical coupler assembly according to paragraph 28.

1. A gangway assembly, comprising:
a gangway for arrangement between two cars of a multi-car vehicle, wherein the gangway comprises a first bellows, the first bellows having a frame for connecting the first bellows to a counter frame of a second bellows of the gangway or to a counter frame of a car;
a first electrical coupler and a second electrical coupler, wherein the first electrical coupler is connected to the frame of the first bellows and the second electrical coupler is one of: a) connected to the counter frame of the second bellows; and b) configured to be connected to a car or counter frame of a car; and
at least one of:
a first support which is fixedly connected to the frame of the first bellows, wherein the first electrical coupler is movably mounted on the first support so as to be movable relative to the frame between an advanced position and a retracted position; and
a second support which is fixedly connected to the counter frame of the second bellows or adapted for being fixedly connected to a car or counter frame of a car, wherein the second electrical coupler is movably mounted on the second support so as to be movable relative to the counter frame or car between an advanced position and a retracted position;
and wherein the gangway assembly further comprises an advancing mechanism operable to advance one or both of the first and second electrical couplers from the respective retracted position to the respective advanced position.

2. The gangway assembly according to claim 1, wherein the gangway assembly comprises both the first support on which the first electrical coupler is movably mounted, and the second support on which the second electrical coupler is movably mounted.

3. The gangway assembly according to claim 1, wherein the first electrical coupler is arranged on an outer side of the frame.

4. The gangway assembly according to claim 1, wherein the advancing mechanism is operable from inside the gangway.

5. The gangway assembly according to claim 1, wherein the frame comprises a through hole connecting an inner side of the frame with an outer side of the frame; and
wherein the advancing mechanism extends through the through hole from inside the first bellows to outside the first bellows and is operable from inside the first bellows.

6. The gangway assembly according to claim 5, wherein the advancing mechanism comprises an operating spindle which extends through the through hole and which is configured so that turning the operating spindle causes advancement of the first electrical coupler from its retracted position to its advanced position.

7. The gangway assembly according to claim 6, wherein the advancing mechanism further comprises an advancement shaft; and wherein the operating spindle and advancement shaft engage each other so that turning the operating spindle causes advancement of the first electrical coupler from its retracted position to its advanced position by means of the advancement shaft.

8. The gangway assembly according to claim 7, wherein the advancement shaft is stationary and has a thread which engages a part of the first electrical coupler so that rotation of the advancement shaft causes the advancement of the first electrical coupler from its retracted position to its advanced position.

9. The gangway assembly according to claim 7, wherein the operating spindle and advancement shaft engage each other either by means of a worm gear or by means of a swing lever.

10. The gangway assembly according to claim 1, further comprising: a marker which is visible from inside the gangway 1; and an indicator visible from inside the gangway 1 and arranged such that it changes position relative to the marker when the first electrical coupler moves from its retracted position to its advanced position.

11. The gangway assembly according to claim 10, wherein the marker is arranged on an inner side of the frame.

12. The gangway assembly according to claim 1, further comprising a removable handle configured to be connected to the advancing mechanism from inside the gangway and for manually operating the advancing mechanism from inside the gangway so as to advance the first electrical coupler from its retracted position to its advanced position.

13. The gangway assembly according to claim 12, further comprising a motor which is configured to drive the advancing mechanism so as to advance the first electrical coupler from its retracted position to its advanced position.

14. The gangway assembly according to claim 1, wherein each of the first and second electrical couplers comprises a movable front cover which is movable between a closed position, in which it covers electrical contacts of said one of the first and second electrical couplers, and an open position, in which the electrical contacts are uncovered and ready for coupling with electrical contacts of the respective other one of the first and second electrical couplers, wherein the movable front cover is configured to open automatically when the first and second electrical couplers approach each other.

15. The gangway assembly according to claim 1, further comprising a locking mechanism which is configured to permit, after the frame has been connected to the counter frame and prior to operating the advancing mechanism so as to advance one or both of the first and second electrical couplers from the respective retracted position to the respective advanced position, locking the frame to the counter frame.

16. The gangway assembly according to any claim 1, further comprising an elastic connection which permits elastic movement of at least one of the first and second electrical couplers in a direction perpendicular to a longitudinal extension of the first bellows, wherein the elastic connection is realized by at least one of the first and second electrical couplers being elastically mounted on a respective one of the first and second supports so as to allow movement of said at least one of the first and second electrical couplers in a direction perpendicular to an advancement direction of said at least one of the first and second electrical couplers, wherein said at least one of the first and second electrical couplers is elastically mounted on said respective one of the first and second supports by means of an elastomeric material or rubber.

17. The gangway assembly according to claim 1, wherein the first electrical coupler has a first set of redundant electrical contacts and the second electrical coupler has a second set of redundant electrical contacts arranged to mate with the first set of redundant electrical contacts of the first electrical coupler, wherein the arrangement of the first and second sets of redundant electrical contacts is symmetrical with respect to a vertical mid-plane (A) of the respective first and second electrical couplers such that the first set of redundant electrical contacts of the first electrical coupler can mate with the second set of redundant electrical contacts of the second electrical coupler.

18. The gangway assembly according to claim 1, wherein the advancing mechanism comprises a first part and a second part which is separate from but identical in function to the first part, wherein the first part is configured to cooperate with the first electrical coupler, and the second part is configured to cooperate with the second electrical coupler.

19. An electrical coupler assembly comprising:
a first electrical coupler,
a second electrical coupler,
comprising one or both of:
a first support which is configured to be fixedly connected to a frame of a first bellows of a gangway of a multi-car vehicle, wherein the first electrical coupler is movably mounted on the first support so as to be movable relative to the first support between an advanced position and a retracted position, and
a second support which is configured to be fixedly connected to a counter frame of a second bellows of a gangway of a multi-car vehicle or to a car or counter frame of a car of a multi-car vehicle, wherein the second electrical coupler is movably mounted on the second support so as to be movable relative to the second support between an advanced position and a retracted position, and
wherein the electrical coupler assembly further comprises an advancing mechanism operable to advance one or both of the first and second electrical couplers from the respective retracted position to the respective advanced position.

20. The electrical coupler assembly according to claim 19, comprising both said first support and said second support, and wherein the advancing mechanism comprises an operating spindle which is configured so that turning the operating spindle causes advancement of the first electrical coupler from its retracted position to its advanced position.
